(19) United States
(12) Patent Application Publication
(10) Pub. No.: US 2020/0395818 A1
(43) Pub. Date: Dec. 17, 2020

(54) The electric power generation system and Potential energy storage device for a power generation system

(71) Applicant: NISHIKAZE GIKEN KABUSHIKI KAISHA, Fussa-shi, Tokyo (JP)

(72) Inventor: Shinichi NISHIURA, Fussa-shi, Tokyo (JP)

(73) Assignee: NISHIKAZE GIKEN KABUSHIKI KAISHA, Fussa-shi, Tokyo (JP)

(21) Appl. No.: 16/069,147

(22) PCT Filed: Jan. 5, 2017
(86) PCT No.: PCT/JP2017/000077

§ 371 Date: Jul. 10, 2018

(30) Foreign Application Priority Data
Jan. 26, 2016 (JP) 2016-012770

(51) Int. Cl. H02K 7/18; H02K 7/10; H02K 7/108; H02K 7/116; H02K 11/20; F03G 3/00

(52) U.S. Cl. CPC H02K 7/1853; H02K 7/1004; H02K 7/108; F16H 1/06; H02K 11/20; F03G 3/00; H02K 7/116

(57) ABSTRACT

An electric power generation system according to one embodiment is characterized by converting, and storing as potential energy, renewable energy such as wind power and wave power, and thereafter driving an electric power generation device with the released energy. Specifically, a storage device 3 of an electric power generation system 1 is provided with a plurality of sets of weights 30 and pulleys 36, and a wire 37 is hung on the pulleys 36. When the renewable energy rotates a winder 35 in a winding direction, potential energy is stored according to the weight of the weights 30 and the rising distance of the weights 30. When the winder 35 becomes rotatable in a direction opposite to the winding direction, the stored potential energy is released, becomes continuous power according to gravity and acceleration of the weights 30, and turns a generator connected to the winder 35. According to the present invention, a large amount of power can be obtained for stably driving the electric power generation device, even in an unstable and intermittent renewable energy environment.

### DETAILED DESCRIPTION OF THE INVENTION

### Field of the Invention

The present invention, the wind generated in nature, tides of sea waves, etc. river, flow and fluid power generation system which generates electric power through the use of other renewable energy, particularly preferred, on average, low renewable energy and a power generation system generating system that utilizes renewable energy in an environment where the continuity of the energy of the flame, and temporarily stores these reproduction energy as potential energy, and sends the potential energy in the generator as an energy, suitable for generating about use potential energy storage device.

### BACKGROUND OF THE INVENTION

Power generation systems utilizing renewable energy are what are used in environments where high energy obtained as far as possible continuously is common.

For example, in wind power generation, coastal and offshore strong winds can be expected, or summit, and the installation of the hillside to, such as the mainstream.

Furthermore, the energy receiving mechanism (blade) is placed in a high place of tens of meters. In the wave power, practical examples are very few, looking at the example of development has been attempted so far, and the installation of a high wave height offshore has become the mainstream. In addition, these are the mainly large-scale facilities.

Local production for local consumption of renewable energy has long been said.

Therefore, practical as consumer products, medium, those small and the realization of such wave power of wind power and cove in urban areas, a common environment is expected.

However, current is limited to a very ancillary ones, it has not yet appeared to have an alternative ability as electric power generator. The biggest reason is the environment in which it is installed.

When the wind power as an example, wind speed of annual average of the Tokyo metropolitan area of the roof of the building is about 3 m.

Many days with no wind, the continuity of the energy is also bad. In the wind power generator that has been sold to a consumer, although there is a product that claims to power generation capacity of 2000 kWh, it is the ability assuming strong winds like 15 m wind speed, a strong wind does not occur many times in the city.

When such products use of actually Tokyo annual average wind speed 3m (one-fifth of the wind),

Occurs the following various problems, such as, the electric power generation capacity drops to about 100 kWh which is one twentieth of the wind speed.

1. At the time of breeze, the problem of the threshold of the energy receiving part occurs. For example, the blade does not rotate due to the mechanical load of the system, such as the weight of the blade (wing), the torque of the motor shaft, etc.

2. Even if the wind speed of the blade (wing) reaches, the electric power of the generator cannot be used unless it reaches the rotation speed until electricity generation of the generator, that problem of the threshold of the electric power generation system arises.

3. A problem of power generation efficiency arises.

Even if the rotating speed reaches the power generation, the received energy is consumed by the electric power loss due to the load in the system.

4. There arises a problem of electric power storage performance of an electric power storage device such as a battery due to discontinuity of electric power generation.

Even if wind power turns the blade and sufficient electric power is generated and stored in an electric power storage device such as a battery, if there is no wind and the period of time not to generate electricity lasts long, spontaneous discharge occurs in the battery.

On the other hand, in wave power generation with wave energy up down (wave height) as energy source,

Sea creeks of installation environment that are practical for civilian use are wave height of several 10 cm average annually, but offshore annual average wave height of several meters. If we read the wave height as the wind speed, we will not wait for the issue to arise that exactly the same problem as wind power generation.

In order to solve such problems, multiple electric power generation motor capable of generating electric power at low speed, battery charger with computer controlled electric power, and the like have been proposed. Both of them are expensive because of their effectiveness and are currently not adopted in terms of cost performance.

Under these circumstances, an electric power generation system that can be practically used even in a civilian environment that is small, medium-sized, and poor in regenerative energy environment that can be provided for consumer use has been sought.

In Patent Document 1,

An electric power generation device utilizing the principle of a so-called “water drink bird” that moves by repeating a thermodynamic cycle with the essential energy source as the heat of the surrounding environment is disclosed.

It is not an effective device for use in a civilian environment where the renewable energy environment is poor.

Patent Document 2 discloses a load utilization device using the potential energy of a load such as water, which is an improved overhung type turbine.

It utilizes the difference in elevation of water flow and it cannot be said to be an effective device for use in a consumer environment where the renewable energy environment is poor.

### CITATION LIST

### Patent Literature

[Patent document 1] JP 2008-75640A
[Patent document 2] JP 2014-101879A
[Patent document 3] JP,5524409,B

### SUMMARY OF INVENTION

### Problem to be Solved by the Invention

The inventor of the present invention focused on the fact that this kind of renewable energy electric power generation system directly connects kinetic energy of renewable energy to a generator. In this state, the efficiency of electric power conversion is determined by the level of renewable energy and the conversion efficiency of the electric power generation motor and input of low renewable energy is remarkably disadvantageous as in the above problem. In addition, since there is no countermeasure against energy continuity, spontaneous discharge in an electric power storage device such as a battery cannot be avoided.

In view of this, the inventor of the present invention has proposed a system in which storage device of renewable energy are provided in front of a generator.

If kinetic energy can be accumulated, small kinetic energy and intermittent kinetic energy are converted into large continuous kinetic energy, For example.

We can overcome environmental problems such as low renewable energy and generation of intermittent energy that are obstacles to the realization of civilian renewable energy such as wind power generation in urban areas and wave power generation in coves I found out.

That is, the problem of the present invention has been made in view of the above circumstances.

It is an object of the present invention to provide a electric power generation system that can be used even in a civilian environment, that is small, medium size, poor in renewable energy environment that can be used for civilian use, and a the electric power generation and potential energy storage device for a electric power generation system.

### Means for Solving Problem

The first invention is

An electric power generation system comprising:

a receiving device for receiving renewal energy to generate a first power;

a storage device that stores a potential energy using the first power and generates a second power that is larger than the first power using the stored the potential energy;

and

an electric power generator device converting the second power into electric power, wherein the storage device further comprises
a weight;
a winder;
a wire whose both ends are respectively connected to the weight and the winder; and
a switching mechanism for switching between a first state in which rotation of the winder in a winding direction is permitted and rotation of the winder in a feeding direction opposite to the winding direction is not permitted and the second state in which the winder is allowed to rotate in the feeding direction, wherein the first power rotates the winder in the winding direction, the wire is wound up to raise the weight, as the weight goes down by its own weight, the winder rotates in the feeding direction to generate the second power.

The second invention is

The electric power generation system according to first invention, wherein the storage device reciprocates the weight in the direction of gravity by the first power, When the weight is descending, the potential energy corresponding to the descending distance of the weight is converted into the second power.

The third invention is, the electric power generation system according to first invention or second invention, wherein the storage device may further include a pulley, both ends of the linear body are connected to the weight and the winder, respectively, and are wound around the pulley.

A fourth invention is the electric power generation system according to any one of first invention to third invention. Wherein Further comprising a first shaft connecting the receiving device and the storage device and a second shaft connecting the storage device and the electric power generating device, The first power is transmitted to the storage device by a rotational motion of the first shaft, The second power is transmitted to the electric power generation device by a rotational motion of the second shaft.

A fifth invention is the electric power generation system according to fourth invention.

Wherein a third shaft serving as a rotating shaft of the winder, A first gear train disposed between the first shaft and the third shaft, And a second gear train disposed between the second shaft and the third shaft.

A sixth invention is and the electric power generation system according to any one of first invention to fifth invention. Wherein the storage device may further include a sensor that detects the weight at a reference position, and the switching mechanism switches the first state to the second state in response to the sensor detecting the weight.

A seventh invention is the electric power generation system according to fifth invention. Wherein the switching mechanism includes a bi-directional clutch gear included in at least one of the first gear train and the second gear train, The two-way clutch gear can switch between a driving direction and a slipping direction, The switching mechanism switches between the first state and the second state by switching between the driving direction and the idling direction of the bi-directional clutch gear.

The eighth invention is

A potential energy storage device for a power generation system comprising:
a receiving device for receiving energy to generate a first power;

a storage device that stores a potential energy using the first power and generates a second power that is larger than the first power using the stored the potential energy;

and

an electric power generator device converting the second power into electric power, wherein the storage device further comprises
a weight;
a winder;
a wire whose both ends are respectively connected to the weight and the winder; and
a switching mechanism for switching between a first state in which rotation of the winder in a winding direction is permitted and rotation of the winder in a feeding direction opposite to the winding direction is not permitted and the second state in which the winder is allowed to rotate in the feeding direction, wherein the first power rotates the winder in the winding direction, the wire is wound up to raise the weight, as the weight goes down by its own weight, the winder rotates in the feeding direction to generate the second power.

A ninth invention is Potential energy storage device for the electric power generation system according to eighth invention, wherein the storage device reciprocates the weight in the direction of gravity by the first power, When the weight is descending, the potential energy corresponding to the descending distance of the weight is converted into the second power.

A tenth invention is Potential energy storage device for the electric power generation system according to eighth invention or ninth invention, wherein the storage device may further include a pulley, both ends of the linear body are connected to the weight and the winder, respectively, and are wound around the pulley.

An eleventh invention is Potential energy storage device for the electric power generation system according to any one of eighth invention to tenth invention. Wherein Further comprising a first shaft connecting the receiving device and the storage device and a second shaft connecting the storage device and the electric power generating device, The first power is transmitted to the storage device by a rotational motion of the first shaft, The second power is transmitted to the electric power generation device by a rotational motion of the second shaft.

A twelfth invention is Potential energy storage device for the electric power generation system according to eleventh invention. Wherein a third shaft serving as a rotating shaft of the winder, A first gear train disposed between the first shaft and the third shaft, And a second gear train disposed between the second shaft and the third shaft.

A thirteenth invention is Potential energy storage device for the electric power generation system according to any one of eighth invention to twelfth invention. Wherein the storage device may further include a sensor that detects the weight at a reference position, and the switching mechanism switches the first state to the second state in response to the sensor detecting the weight.

A fourteenth invention is Potential energy storage device for the electric power generation system according to thirteenth invention. Wherein the switching mechanism includes a bi-directional clutch gear included in at least one of the first gear train and the second gear train, The two-way clutch gear can switch between a driving direction and a slipping direction, The switching mechanism switches between the first state and the second state by switching between the driving direction and the idling direction of the bi-directional clutch gear.

### Effect of the Invention

According to the present invention, it is possible to provide a electric power generation system that can be practically used even in a civilian environment of small size, medium size, poor renewable energy environment that can be provided for civilian use, and a potential energy storage device that is applied to this electric power generation system.

### BRIEF DESCRIPTION OF THE DRAWINGS

FIG. 1 is a diagram showing a schematic configuration of an electric power generation system according to a first embodiment.

FIG. 2 is a diagram schematically showing a first gear train and a second gear train.

FIG. 3 is a diagram showing a storage device at the time of accumulating potential energy.

FIG. 4 is a view showing a storage device in which a weight rises to the uppermost portion.

FIG. 5 is a diagram showing a storage device at the time of using potential energy.

FIG. 6 is a diagram showing a schematic configuration of an electric power generation system according to a second embodiment.

### DESCRIPTION OF EMBODIMENTS

Per some embodiment s will be described with reference to the drawings.

### First Embodiment

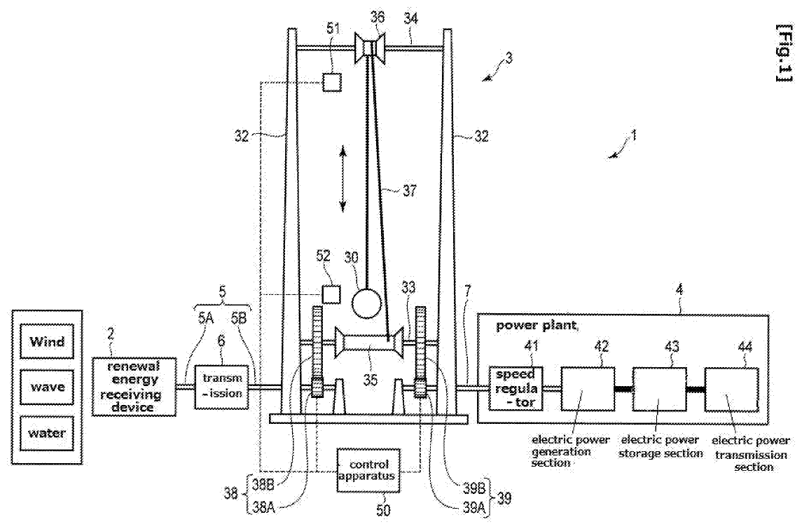

FIG. 1 is a diagram showing a schematic configuration of an electric power generation system 1 according to a first embodiment. The electric power generation system 1 includes a renewable energy receiving device 2 (hereinafter referred to as a receiving device 2), a storage device 3, and an electric power generation device 4. The receiving device 2 receives the renewable energy and generates a first power. The renewable energy can utilize various energies caused by fluid flow such as wind force, wave force that is a force of water surface move up and down such as the ocean, water discharge of the dam or water flowing in a river. In addition, as the renewable energy, tidal power that is the tidal power of tide and steam generated by using geothermal may be used. Renewable energy is sometimes called regeneration energy.

These renewable energy receiving device itself, for example, are known to those skilled in the art, such as JP2015-17614 and JP 2015-17622. The reproduction energy receiving device of the present invention of course not limited to the device described in JP 2015-17614 and JP 2015-17622.

The receiving device 2 and the storage device 3 are connected by a first shaft 5.

In the example of FIG. 1, the first power generated by the receiving device 2 is transmitted to the storage device 3 via the first shaft 5.

As a mechanism for the receiving device 2 to receive the renewable energy to generate the first power, various mechanisms can be adopted. For example, when the renewable energy is wind power, the receiving device 2 includes a blade that rotates by receiving wind power and an electric power generation mechanism that rotates the first shaft 5 in accordance with the rotation of the blade.

When the renewable energy is wave force, the receiving device 2 includes a floating body that moves up and down along with the water surface, and an electric power generation mechanism that rotates the first shaft 5 according to the vertical movement of the floating body.

When the renewable energy is hydraulic power, the receiving device 2 includes a turbine rotating by receiving hydraulic power and an electric power generation mechanism for rotating the first shaft 5 in accordance with the rotation of the turbine.

The configuration of the electric power generation mechanism is not particularly limited.

For example, in the case of wind power or hydraulic power, it may include a gear train that transmits rotational motion of the blade or turbine to the first shaft 5.

Further, in the case of wave force. It may include a rack reciprocating with upward and downward movements of the floating body and a gear train meshing with the rack and rotated by the reciprocating motion of the rack to rotate the first shaft 5.

The rotational motion of the blade or the turbine and the vertical movement of the floating body may be converted to the reciprocating motion of the cable and then converted into the rotational motion of the first shaft 5.

As the cable, for example, it is possible to adopt a structure including a hollow outer cable and an inner cable passed through the inside of the outer cable, and the inner cable reciprocates inside the outer cable.

By providing flexibility to the outer cable and the inner cable, even when the mechanism for converting the reciprocating motion of the inner cable into the rotational motion is installed at a position away from the installation position of the blade, the turbine, or the floating body, it is possible to easily connect the both.

In the example of FIG. 1, a transmission 6 is interposed between the receiving device 2 and the storage device 3.

Further, the first shaft 5 includes a shaft 5 A connecting the receiving device 2 and the transmission 6, and a shaft 5 B connecting the transmission 6 and the storage device 3. In this configuration, the shaft 5A is rotated by the first power of the receiving device 2. The transmission 6 shifts (accelerates or decelerates) the rotation speed of the shaft 5A, and rotates the shaft 5 B at the rotation speed after the shift.

The speed increasing ratio or the reduction ratio of the transmission 6 may be appropriately determined in consideration of the number of revolutions and torque obtained by the receiving device 2, the number of revolutions and torque required in the accumulating device 3, and the like.

The storage device 3 and the electric power generation device 4 are connected by a second shaft 7. Although described in detail later, the storage device 3 stores the potential energy using the first power transmitted via the first shaft 5 and generates the second power by using the stored potential energy. The second power is transmitted to the electric power generation device 4 as a rotational motion of the second shaft 7. The electric power generation device 4 converts the second power into electric power. As a specific configuration of the electric power generation device 4, various ones can be adopted. As an example, the electric power generation device 4 shown in FIG. 1 includes a speed regulator 41, an electric power generation section 42, an electric power storage section 43, and an electric power transmission section 44. The second shaft 7 is connected to the speed regulator 41 and the electric power generation section 42. The speed regulator 41 adjusts the rotational speed of the second shaft 7 within a speed range suitable for electric power generation. As the speed governor 41, for example, a centrifugal governor or the like can be used. The electric power generation section 42 generates electric power based on the rotational motion of the second shaft 7. As a configuration of such an electric power generation section 42, various known configurations can be adopted. The electric power storage section 43 includes a battery that stores electric power generated by the electric power generation section 42. The electric power transmission section 44 supplies the electric power stored in the electric power storage section 43 to the electric power transmission line at a predetermined voltage and current. The transmission line may be a part of an existing electric power transmission network or may be provided specialized for use in a specific building such as a factory, a building, a house, or the like.

The storage device 3 is provided with a weight 30 and stores the potential energy corresponding to the weight of the weight 30 and the elevated distance by raising the weight 30 in the anti-gravity direction using the first power. Further, the storage device 3 generates the second power by using the stored potential energy by lowering the weight 30 in the direction of gravity. In this way, the storage device 3 accumulates and utilizes potential energy by the vertical movement (the elevating motion or the reciprocating motion in the direction of gravity) of the weight 30. The structure of the storage device 3 is not particularly limited as long as it exhibits such a function. In the example of FIG. 1, the storage device 3 includes a pair of support columns 32, a third shaft 33, a shaft member 34, a winder 35, a pulley 36, and a wire 37. Both ends of the third shaft 33 are rotatably supported by a shaft by a pair of support columns 32. Both ends of the shaft member 34 are supported by a pair of support columns 32 at a position higher than the third shaft 33. The winder 35 is attached to the third shaft 33 and rotates with the rotation of the third shaft 33. The pulley 36 is rotatably supported on the shaft by the shaft member 34. One end of the wire 37 is connected to the winder 35, and the other end is connected to the weight 30. Further, the wire 37 is hooked on a pulley 36. As the wire 37, for example, a single wire, a double wire, a twisted wire, a chain, or the like can be used as appropriate.

In such a configuration, when the third shaft 33 rotates in a certain direction, the winder 35 winds the wire 37 and the weight 30 rises. In addition, when the weight 30 descends due to its own weight, the wire 37 wound around the winder 35 is paid out and the third shaft 33 rotates in the opposite direction. Hereinafter, the direction of rotation of the winder 35 when winding the wire 37 is referred to as the winding direction and the direction of rotation of the winder 35 when the wire 37 is fed out is called the feeding direction. The storage device 3 further includes a first gear train 38 and a second gear train 39. The first gear train 38 transmits the rotational motion of the first shaft 5 (shaft 5 B) to the third shaft 33 at the time of winding the wire 37. The second gear train 39 transmits the rotational motion of the third shaft 33 to the second shaft 7 when the wire 37 is unwound. In the example of FIG. 1, the first gear train 38 includes gears 38 a, 38 B (first gear) that are meshed with each other. The gear 38 A is attached to the first shaft 5 (shaft 5 B) and rotates about the shaft 5B. The gear 38 B is attached to the third shaft 33 and rotates about the third shaft 33. The gear 38 A has a smaller diameter than the gear 38 B.

On the other hand, the second gear train 39 includes gears 39 A and gear 39 B (second gear) meshed with each other. The gear 39A is attached to the second shaft 7 and rotates about the second shaft 7. The gear 39B is attached to the third shaft 33 and rotates about the third shaft 33. The gear 39A has a smaller diameter than the gear 39 B. In the present embodiment, the second power is greater than the first power. Further, the second power exceeds the load of at least the electric power generation device 4 here; the power is the work amount per unit time, for example. As for the rotating body, it can be defined as a value proportional to the product of torque and rotation speed.

The first power is generated based on the unstable renewable and varies according to the magnitude of renewable energy. Therefore, the first power temporarily becomes larger than the second power in some cases. In the present embodiment, “the second power is greater than the first power” does not exclude the case where the first power temporarily exceeds the second power temporarily. The time average value of the first power is intended to be smaller than the second power. The storage device 3 further includes a control apparatus 50, a first sensor 51, and a second sensor 52. The first sensor 51 is disposed at a high place close to the region where the weight 30 moves up and down. The second sensor 52 is disposed at a low place close to the region where the weight 30 moves up and down. The first sensor 51 detects the weight 30 at the first reference position (P1 to be described later). The second sensor 52 detects the weight 30 at a second reference position (P2 to be described later) below the first reference position in the direction of gravity.

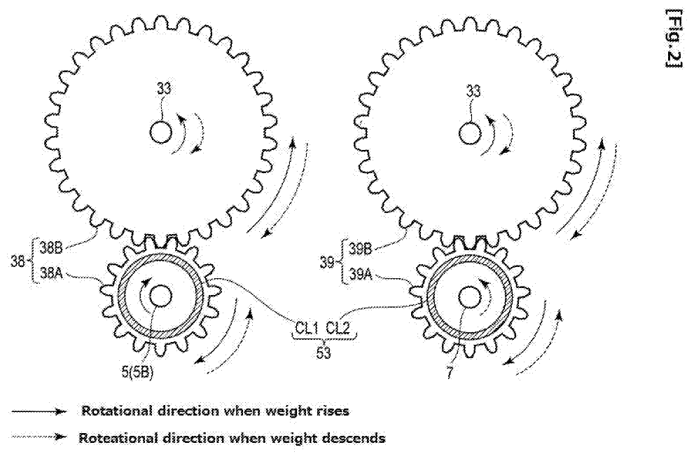

In the present embodiment, the gears 38A, 39A have a bi-directional clutch mechanism (CL1, CL2 to be described later) capable of switching between the driving direction and the idling direction. This clutch mechanism switches the driving direction and the idling direction by electromagnetic control, for example, and is controlled by the control apparatus 50. The control apparatus 50 controls clutch mechanisms of the gears 38 A, 39 A based on the detection signals of the first sensor 51 and the second sensor 52. FIG. 2 schematically shows the first gear train 38 and the second gear train 39. The first clutch mechanism CL 1 of the gear 38 A and the second clutch mechanism CL 2 of the gear 39 A constitute the switching mechanism 53. The switching mechanism 53 allows rotation of the winder 35 in the take-up direction. Then, the first state in which rotation of the winder 35 in the feeding direction is not permitted, and the second state in which the rotation of the winder 35 in the feeding direction is permitted are switched.

The first clutch mechanism CL1 is a bi-directional clutch mechanism capable of switching between the driving direction and the idling direction.

That is, the gear 38 A functions as a bi-directional clutch gear.

The driving direction is the rotation direction of the gear 38A transmitting the power between the first shaft 5 and the gear 38B and the idling direction is the rotation direction of the gear 38A not transmitting the power between the first shaft 5 and the gear 38B is there.

On the other hand, the second clutch mechanism CL 2 is a unidirectional clutch mechanism having a driving direction and an idling direction, but these cannot be switched.

That is, the gear 39 A functions as a one-way clutch gear.

However, a bi-directional clutch mechanism may be used as the second clutch mechanism CL 2.

In FIG. 2, the arrow indicated by the solid line shows the rotational direction of each gear at the time of storing the potential energy.

On the other hand, the arrow indicated by the broken line shows the rotation direction of each gear at the time of using the potential energy.

The first shaft 5 rotates in the same direction both during the accumulation of the potential energy and during the use energy.

At the time of accumulating the potential energy, the drive direction and the idle direction of the first clutch mechanism CL 1 are set such that the gear 38 A rotates in the direction of the solid arrow as receiving the rotation of the first shaft 5.

The gear 38 B, the third shaft 33, the gear 39 B, and the gear 39 A rotate in the direction indicated by the solid arrow in response to the rotation of the gear 38 A.

At this time, the driving direction and the rotating direction of the second clutch mechanism CL 2 are set so that the gear 39 A idles and the second shaft 7 does not rotate.

The pulley 36 rotates in the take-up direction together with the third shaft 33, the wire 37 is wound up, and the weight 30 rises.

During the use of potential energy, as the weight 30 descends, the pulley 36 rotates in the feeding direction, and the third shaft 33 rotates in the direction indicated by the broken line arrow.

In response to the rotation of the third shaft 33, the gear 38B and the gear 39B rotate in the direction indicated by the broken line arrow, whereby the gear 39A and the gear 39A also rotate in the direction indicated by the broken line arrow.

At the time of using the potential energy, the driving direction of the first clutch mechanism CL1 and the idling direction are reversed by the control of the control apparatus 50.

Therefore, since the gear 38A idles, the rotation of the gear 38 A is not transmitted to the first shaft 5.

On the other hand, since the rotation of the gear 39A coincides with the driving direction of the second clutch mechanism CL2, the second shaft 7 rotates in response to the rotation of the gear 39A. Receiving the rotation (second power) of the second shaft 7, the electric power generation device 4 can generate electric power.

It is necessary to prevent the descent of the weight 30 at the time of accumulating the potential energy.

In the present embodiment, descent of the weight 30 is prevented by using the load of the first shaft 5 (the load of the receiving device 2 and the transmission 6) and the load of the second shaft 7 (the load of the electric power generating device 4).

That is, even when the weight 30 tries to descend at the time of accumulating the potential energy, the rotational directions of the gear 38 A and the gear 39 A at this time coincide with the driving direction.

Therefore, the loads of the first shaft 5 and the second shaft 7 simultaneously act to prevent the weight 30 from being lowered.

Here, an example in which the load of the first shaft 5 and the second shaft 7 is used to prevent the weight 30 from being lowered is shown.

By providing a separate mechanism, it is also possible to prevent the descent of the weight 30 during energy storage.

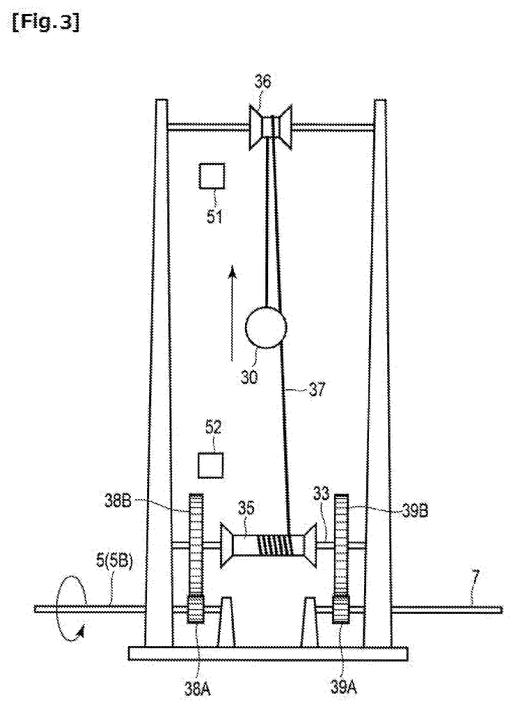

Subsequently, the operation of the storage device 3 will be described with reference to FIG. 3 to 5.

Upon storing the potential energy, the storage device 3 is set to the above-described first state.

At this time, due to the first power transmitted via the first shaft 5, the first gear train 38 rotates the second shaft 33 in the take-up direction.

Along with this, the winder 35 winds up the wire 37, and the weight 30 rises as shown in FIG. 3.

Positional energy corresponding to the rising distance of the weight 30 is accumulated in the storage device 3.

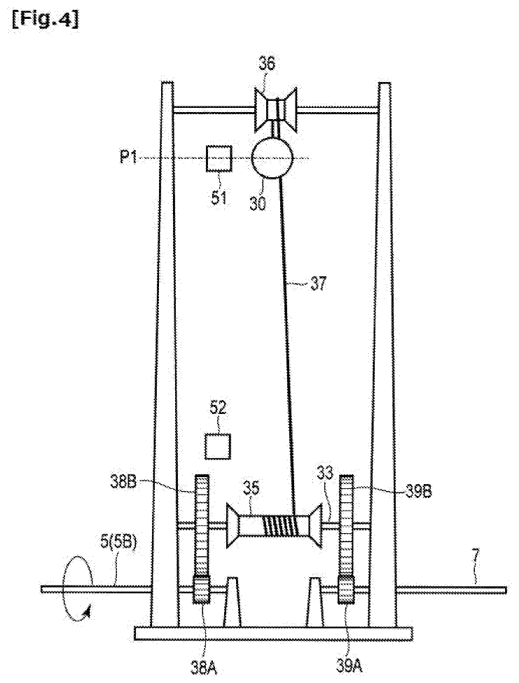

Eventually, as shown in FIG. 4, when the weight 30 reaches the first reference position P 1, the first sensor 51 detects the weight 30.

At this time, the first sensor 51 outputs a detection signal to the control apparatus 50.

Upon receiving the detection signal from the first sensor 51, the control apparatus 50 controls the switching mechanism 53 (mainly the first clutch mechanism CL 1 to switch the storage device 3 to the above-described second state.

At the first reference position P 1, the weight 30 may be at the top dead center where it cannot be further increased.

For example, it is possible to determine this top dead center by disposing a member that regulates the ascent of the weight 30.

At the top dead center, the weight 30 stops, and along with this, the third shaft 33 and each gear also stop.

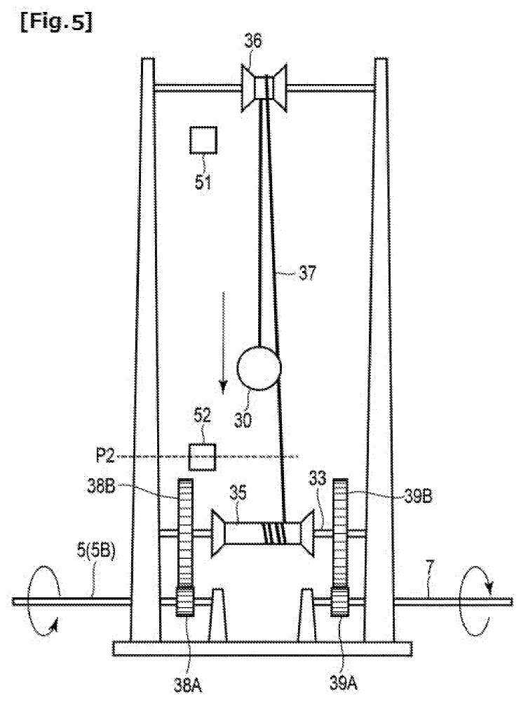

When switching to the second state, the weight 30 descends due to its own weight as shown in FIG. 5.

That is, the winder 35 and the third shaft 33 rotate in the feeding direction.

The rotation of the third shaft 33 in the feeding direction is transmitted to the second shaft 7 via the second gear train 39, and the second shaft 7 rotates.

Upon receiving the rotational motion of the second shaft 7, that is, the second power, the electric power generation device 4 generates electric power.

Thereafter, when the weight 30 reaches the second reference position P2, the second sensor 52 detects the weight 30.

At this time, the second sensor 52 outputs a detection signal to the control apparatus 50.

Upon receiving the detection signal from the second sensor 52, the control apparatus 50 controls the switching mechanism 53 (mainly the first clutch mechanism CL 1 and switches the second state to the first state.

As a result, the storage device 3 stores the potential energy again using the first power.

At the second reference position P 2, the weight 30 may be at a bottom dead center where it cannot descend further.

For example, by arranging a member for restricting the descent of the weight 30, this bottom dead center can be determined.

Alternatively, the position of the weight 30 when all of the wire 37 is unwound from the winder 35 may be the bottom dead center.

At the bottom dead center, the weight 30 stops, and along with this, the third shaft 33 and each gear also stop.

As described above, the electric power generation system 1 according to the present embodiment repeats accumulation and use of potential energy.

The first power obtained from renewable energy is unstable, it is not always possible to obtain a value suitable for power generation, and sometimes it may stop.

In the conventional power generation system, in the case where the power from the receiving device is lower than the load of the electric power generation device, for example, the electric power generation device does not operate and electric power cannot be obtained in some cases.

In this case, the power generated by the receiving device is wasted.

On the other hand, in the electric power generation system 1 according to the present embodiment, even when the first power generated by the reception device 2 is small, the first power can be effectively utilized to generate electric power.

That is, the first power from the receiving device 2 is once stored as potential energy in the storage device 3.

When the potential energy is sufficiently stored, the storage device 3 generates the second power that exceeds the load of the electric power generation device 4 by using the potential energy.

This second power corresponds to the energy when the weight 30 descends due to its own weight, so it is extremely stable.

Besides this, various effects already described can be obtained from this embodiment.

### Second Embodiment

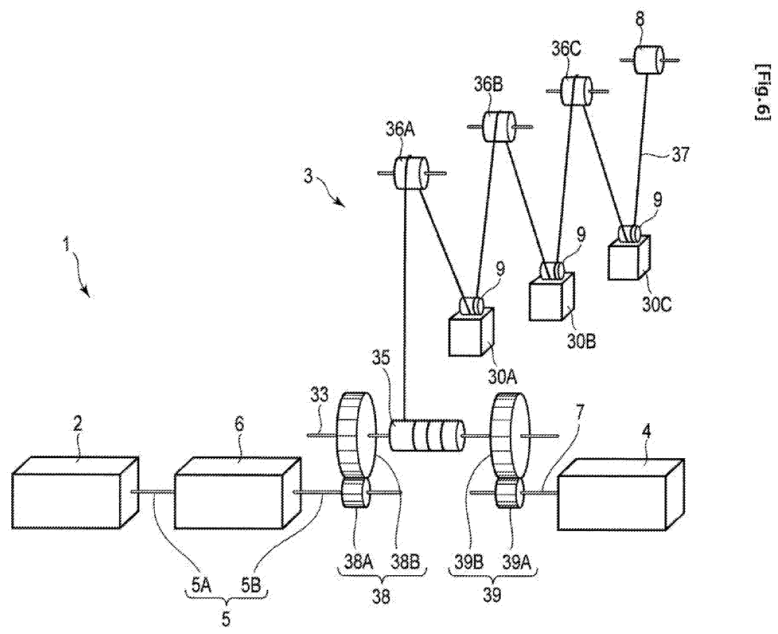

A second embodiment will be described. Elements that are the same as or similar to those of the first embodiment are denoted by the same reference numerals, and differences from the first embodiment will be mainly described. FIG. 6 is a diagram showing a schematic configuration of the electric power generation system 1 according to the present embodiment. This electric power generation system 1 is different from that shown in FIG. 1 in the configuration of the storage device 3. That is, the storage device 3 includes n weights 30 (n is an integer of 2 or more) and n pulleys 36. In the example of FIG. 6, n=3 and the storage device 3 is provided with weights 30A, 30B, 30C and pulleys 36A, 36B, 36C. However, n may be another value. Further, in the example of FIG. 6, one end of the wire 37 is connected to the winder 35, and the other end is connected to the terminator 8. The wire 37 is hooked on pulleys 36A, 36B, 36C. The pulleys 36 A, 36 B, 36 C and the terminator 8 have, for example, the same height in the direction of gravity.

A rotatable roller 9 is attached to the upper surfaces of the weights 30 A, 30 B, and 30 C. a wire 37 is hung on each roller 9, whereby the weights 30 A, 30 B, 30 C are connected to the wire 37. In such a configuration, when the winder 35 is rotated in the take-up direction by the first power, the wire 37 is wound around the winder 35 and the weights 30A, 30B, 30C are raised in the direction of gravity. As a result, the potential energy corresponding to the weight of the weights 30A, 30B, 30C and the distance by which the weights 30A, 30B, 30C are raised is accumulated. On the other hand, when the weights 30A, 30B, 30C descend in the direction of gravitational force due to its own weight, the winder 35 rotates in the feeding direction, the wire 37 is fed out from the winder 35, and the third shaft 33 rotates. The rotation of the third shaft 33 in the feeding direction is transmitted to the second shaft 7 via the second gear train 39, and the second shaft 7 rotates. Upon receiving the rotational motion of the second shaft 7, that is, the second power, the electric power generating device 4 generates electric power.

Although not shown in FIG. 6, the storage device 3 includes a first sensor 51, a second sensor 52, and a control apparatus 50 as in the first embodiment.

For example, the first sensor 51 and the second sensor 52 may detect any one of the weights 3A, 30B, and 30C.

In the configuration of the present embodiment, it is possible to store the potential energy dispersed in the plurality of weights 30.

Therefore, even if the ascent distance of the weight 30 is made small, sufficient positional energy can be stored.

In the example of FIG. 6, it is assumed that the weight of each of the weights 30 A, 30 B, and 30 C is the same as the weight of the weight 30 shown in FIG. 1. In that case, in the case of storing the same potential energy, in the example of FIG. 6, it may be 1/3 of FIG. 1.

In addition, various preferred effects can be obtained from this embodiment.

The present invention can be implemented with various modifications to the configurations of the above-described embodiment s. For example, the configurations disclosed in the respective embodiment s may be appropriately combined. Modified embodiment s within the scope not deviating from the gist of the invention is included in the invention described in the claims and their equivalent scope.

For example, the storage device 3 may be provided with a member for guiding the vertical movement of the weight 30. By providing such a member, it is possible to stably move the weight 30 up and down.

The storage device 3 may have a mechanism for transmitting the first power from the receiving device 2 to the electric power generation device 4 as it is, and may switch between this mechanism and the mechanism for accumulating potential energy. In this case, when the renewable energy is sufficiently strong, for example, when strong wind is blowing, it is possible to generate electric power using the first power.

The control method by which the control apparatus 50 switches between the first state and the second state is not limited to the above-described one.

For example, it may be switched to the first state when a certain time has elapsed after the first sensor 51 detects the weight 30 and switched to the second state.

In this case, the second sensor 52 is unnecessary.

In addition, after the second sensor 52 has detected the weight 30 and switched to the first state, the second state may be switched to the second state when a certain period of time has elapsed.

In this case, the first sensor 51 is unnecessary. In addition, the first state and the second state may be switched at regular time intervals.

In this case, both the first sensor 51 and the second sensor 52 are unnecessary.

Further, the number of revolutions of the winder 35 or the like may be counted, and the first state and the second state may be switched in accordance with this count value. In addition, various control methods can be adopted.

### INDUSTRIAL APPLICABILITY

According to the present invention, among the many problems that the electric power generation system utilizing the conventional renewable energy has, at least the problem of the operation start threshold of the energy receiving unit, the problem of the threshold of the electric power generation system, the problem of the electric power generation efficiency, It is possible to solve the problem of the electric power storage performance of the electric power storage device such as a battery due to the discontinuity of the electric power storage device.

(Solving the Problem of Starting Threshold of Energy Acceptance)

In the conventional wind power generator, since the kinetic energy has a torque that does not lose to the load on the generator side, the blade needs to be robust and tends to be heavy. As a result, the threshold of the wind force until the blade begins to turn increases. In the present invention, the kinetic energy of renewable energy is not a generator but a transmission as an inlet, so that the load on the energy receiving portion can be freely reduced by the rate of change. Therefore, in extreme terms, the blade is made of a cloth-like material, and it is possible to design such that it can be easily rotated even with a breeze.

(Solving the Threshold Problem of Electric Power Generation System)

Conventionally, even when the wind speed of the blade (feather) reaches the rotation speed, it cannot be used unless it reaches the rotation speed until the generator motor generates electricity.

On the other hand, in the present invention, since the kinetic energy of the renewable energy is deposited as the potential energy of the weight obtained by winding up the wire by turning the rotor set so as to rotate in only one direction. It is accumulated regardless of discontinuity, and accumulation loss can be reduced.

(Solving Electric Power Generation Efficiency Problem) In the conventional system, even if the receiving unit reaches the rotation speed at which the generator can generate electric power, at a low speed, the energy is consumed by the electric power loss due to the load in the system.

In contrast, in the present invention, the generator operates in an ideal state and generates electricity while satisfying the driving conditions necessary for electric power generation by the potential energy generated by the accumulated weight.

Therefore, according to the present invention, the problem of the threshold of the electric power generation system does not occur.

(Solving the Problem of Electric Power Storage Performance of Electric Power Storage Devices Such as Batteries Due to Discontinuity of Electric Power Generation)

In the conventional system, even if enough electric power is generated and stored in an electric power storage device such as a battery, if the wind is not generated and the period of time during which no electric power is generated lengthens, spontaneous discharge occurs in the battery.

In contrast, according to the present invention, since the energy is stored by arranging the amount of potential energy higher or in parallel, the timing of storing electricity in the battery can be optimally controlled, so the problem of spontaneous discharge can be reduced.

Industrial applicability as described above, according to the present invention, the electric power generation efficiency can be improved with a relatively simple configuration, and a high-efficiency electric power generation system can be realized at low cost. It is certain that this will greatly contribute to the improvement of system performance, and to wind power generation and wave power generation for civilian use.

Furthermore, the potential energy storage device of the present invention can be used not only as a combination with a regenerative energy receiving device but also as a electric power generation device for remote areas or emergency, in combination with external power such as human power and a crane vehicle.

In other words, in a remote site such as in the jungle, instead of renewable energy, one can accumulate potential energy by powering up own manpower and let it generate electricity.

In the event of an emergency, it is possible to supply stable electric power generation for a long time by lifting the weight of the equipment with an external force such as a crane car and adding potential energy.

In other words, the invention described in the present specification includes, together with the invention described in the scope of claims, “A electric power generation system, storing the potential energy by using the first power which is an external power, a storage device for generating a second power greater than the first power by using the stored potential energy, A power generation device that converts the second power into electric power.” and “Storing the potential energy by using the first power which is an external power, A second power greater than the first power is generated using the stored potential energy, potential energy storage device for electric power generation system which can be used for electric power generation.”

### EXPLANATIONS OF LETTERS OR NUMERALS

1: electric power generation system, 2: renewable energy receiving device, 3: storage device, 4: electric power generation device, 5: first shaft, 6: transmission, 7: second shaft, 32: support columns, 33: third shaft, 34: shaft member, 35: winder, 36 pulley, 37: wire, 38: first gear train, 39: second gear train, 41: speed regulator, 42: electric power generation section, 43: electric power storage section, 44: electric power transmission section, 50: control apparatus, 51: first sensor, 52: second sensor, 53: switching mechanism.

1. An electric power generation system comprising:
a receiving device for receiving renewal energy to generate a first power;
a storage device that stores a potential energy using the first power and generates a second power that is larger than the first power using the stored the potential energy;
and
an electric power generator device converting the second power into electric power, wherein the storage device further comprises
a weight;
a winder;
a wire whose both ends are respectively connected to the weight and the winder; and
a switching mechanism for switching between a first state in which rotation of the winder in a winding direction is permitted and rotation of the winder in a feeding direction opposite to the winding direction is not permitted and the second state in which the winder is allowed to rotate in the feeding direction, wherein the first power rotates the winder in the winding direction, the wire is wound up to raise the weight, as the weight goes down by its own weight, the winder rotates in the feeding direction to generate the second power.

2. The electric power generation system according to claim 1, wherein the storage device reciprocates the weight in the direction of gravity by the first power, when the weight is descending, and the potential energy corresponding to the descending distance of the weight is converted into the second power.

3. The electric power generation system according to claim 1, wherein the storage device may further include a pulley,
Both ends of the linear body are connected to the weight and the winder, respectively, and are wound around the pulley.

4. The electric power generation system according to any one of claim 1,
Wherein further comprising a first shaft connecting the receiving device and the storage device and a second shaft connecting the storage device and the electric power generating device,
The first power is transmitted to the storage device by a rotational motion of the first shaft,
The second power is transmitted to the electric power generation device by a rotational motion of the second shaft.

5. The electric power generation system according to claim 4.
Wherein a third shaft serving as a rotating shaft of the winder, A first gear train disposed between the first shaft and the third shaft, And a second gear train disposed between the second shaft and the third shaft.

6. The electric power generation system according to any one of claim 5,
Wherein the storage device may further include a sensor that detects the weight at a reference position, and the switching mechanism switches the first state to the second state in response to the sensor detecting the weight.

7. The electric power generation system according to claim 5.
Wherein the switching mechanism includes a bi-directional clutch gear included in at least one of the first gear train and the second gear train,
The two-way clutch gear can switch between a driving direction and a slipping direction,
The switching mechanism switches between the first state and the second state by switching between the driving direction and the idling direction of the bi-directional clutch gear.

8. A potential energy storage device for a power generation system comprising:
a receiving device for receiving energy to generate a first power;
a storage device that stores a potential energy using the first power and generates a second power that is larger than the first power using the stored the potential energy;
and
an electric power generator device converting the second power into electric power, wherein the storage device further comprises
a weight;
a winder;
a wire whose both ends are respectively connected to the weight and the winder; and
a switching mechanism for switching between a first state in which rotation of the winder in a winding direction is permitted and rotation of the winder in a feeding direction opposite to the winding direction is not permitted and the second state in which the winder is allowed to rotate in the feeding direction, wherein the first power rotates the winder in the winding direction, the wire is wound up to raise the weight, as the weight goes down by its own weight, the winder rotates in the feeding direction to generate the second power.
